(19) United States
(12) Patent Application Publication
(10) Pub. No.: US 2026/0341620 A1
(43) Pub. Date: Oct. 29, 2026

(54) CIRCUIT PROTECTION DEVICE

(71) Applicant: FUZETEC TECHNOLOGY CO., LTD., New Taipei City (TW)

(72) Inventors: Jack Jih-Sang CHEN, New Taipei City (TW); Chang-Hung JIANG, New Taipei City (TW)

(21) Appl. No.: 19/191,954

(22) Filed: Apr. 28, 2025

(51) Int. Cl. H01H 85/048

(52) U.S. Cl. CPC H01H 85/048; H01H 2085/0483

(57) ABSTRACT

A circuit protection device includes a positive temperature coefficient (PTC) layer having a first surface and a second surface, a first conductive layer disposed on the first surface, a second conductive layer disposed on the second surface, a third conductive layer disposed on the PTC layer, a fourth conductive layer disposed on the PTC layer, a fifth conductive layer disposed on the PTC layer, a sixth conductive layer disposed on the PTC layer, an insulation structure which separates the first conductive layer, the second conductive layer, the third conductive layer, the fourth conductive layer, the fifth conductive layer, and the sixth conductive layer, a first electrode electrically connected to the PTC layer, the first conductive layer, the third conductive layer, and the fifth conductive layer, and a second electrode electrically connected to the PTC layer, the second conductive layer, the fourth conductive layer, and the sixth conductive layer.

### FIELD

The disclosure relates to a circuit protection device.

### BACKGROUND

A positive temperature coefficient (PTC) component exhibits a PTC effect and could be used in a circuit protection device such as a resettable fuse. Such a PTC component may include a PTC polymeric unit and first and second electrodes on two opposite surfaces of the PTC polymeric unit. The PTC polymeric unit includes a polymer matrix that contains a crystalline region and a non-crystalline region, and a particulate conductive filler that is dispersed in the non-crystalline region of the polymer matrix and that is formed into conductive pathways for electrical conduction between the first and second electrodes. The PTC effect is a phenomenon that occurs when the temperature of the polymer matrix is raised to its melting point, in which crystals in the crystalline region start to melt. This will result in the generation of a new non-crystalline region. As the new non-crystalline region expands to merge with the original non-crystalline region, the conductive pathways of the particulate conductive filler will gradually be cut-off, and the resistance of the PTC polymer material will sharply increase. This will eventually result in the first and second electrodes becoming electrically disconnected from each other.

In practical application, a PTC circuit protection device with outstanding electric characteristics (e.g., a high working current, a high rated voltage, relatively low resistance, etc.) and thermal stability is highly required in the industry.

### SUMMARY

Therefore, an object of the disclosure is to provide a circuit protection device that can alleviate at least one of the drawbacks of the prior art.

According to the disclosure, a circuit protection device includes a positive temperature coefficient (PTC) layer having a first surface and a second surface opposite to the first surface, a first conductive layer disposed on the first surface of the PTC layer, a second conductive layer disposed on the second surface of the PTC layer, a third conductive layer disposed on the PTC layer 10 and electrically connected to the first conductive layer, a fourth conductive layer disposed on the PTC layer and electrically connected to the second conductive layer, a fifth conductive layer disposed on the PTC layer and electrically connected to the first conductive layer and the third conductive layer, a sixth conductive layer disposed on the PTC layer and electrically connected to the second conductive layer and the fourth conductive layer, an insulation structure which separates the first conductive layer, the second conductive layer, the third conductive layer, the fourth conductive layer, the fifth conductive layer, and the sixth conductive layer, a first electrode electrically connected to the PTC layer, the first conductive layer, the third conductive layer, and the fifth conductive layer, and a second electrode electrically connected to the PTC layer, the second conductive layer, the fourth conductive layer, and the sixth conductive layer.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a cross-sectional schematic view illustrating an embodiment of a circuit protection device according to the present disclosure.

FIG. 2 is a cross-sectional schematic view illustrating an embodiment of a circuit protection device according to the present disclosure.

FIG. 3 is a cross-sectional schematic view illustrating an embodiment of a circuit protection device according to the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

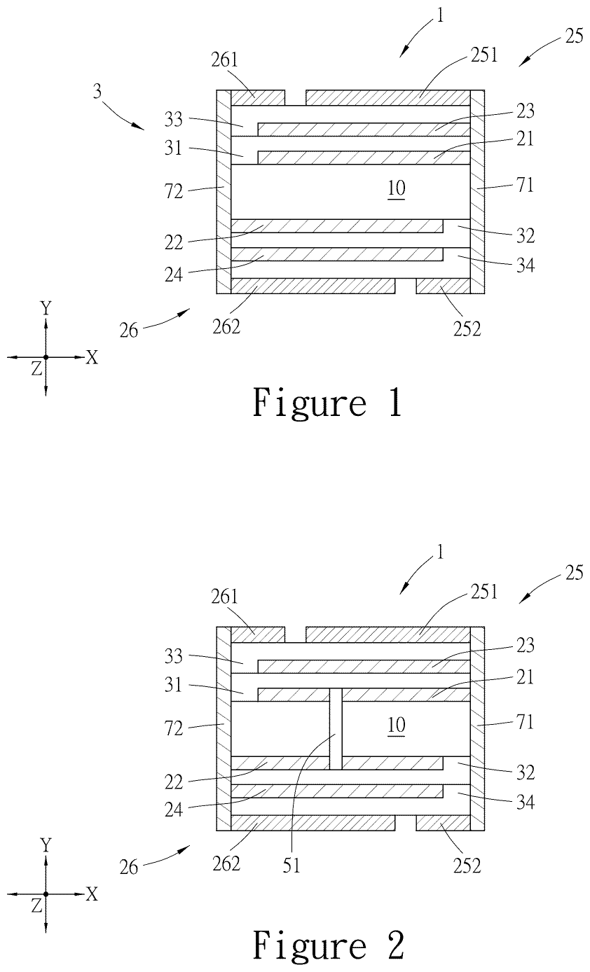

Referring to FIG. 1, an embodiment of a circuit protection device 1 of the present disclosure includes a positive temperature coefficient (PTC) layer 10, a first conductive layer 21, a second conductive layer 22, a third conductive layer 23, a fourth conductive layer 24, a fifth conductive layer 25, a sixth conductive layer 26, an insulation structure 3, a first electrode 71, and a second electrode 72. The PTC layer 10 has a first surface and a second surface opposite to the first surface. The first conductive layer 21 is disposed on the first surface of the PTC layer 10. The second conductive layer 22 is disposed on the second surface of the PTC layer 10. The third conductive layer 23 is disposed on the PTC layer 10 and electrically connected to the first conductive layer 21. The fourth conductive layer 24 is disposed on the PTC layer 10 and electrically connected to the second conductive layer 22. The fifth conductive layer 25 is disposed on the PTC layer 10 and electrically connected to the first conductive layer 21 and the third conductive layer 23. The sixth conductive layer 26 is disposed on the PTC layer 10 and electrically connected to the second conductive layer 22 and the fourth conductive layer 24. The insulation structure 3 separates the first conductive layer 21, the second conductive layer 22, the third conductive layer 23, the fourth conductive layer 24, the fifth conductive layer 25, and the sixth conductive layer 26. The first electrode 71 is electrically connected to the PTC layer 10, the first conductive layer 21, the third conductive layer 23, and the fifth conductive layer 25. The second electrode 72 is electrically connected to the PTC layer 10, the second conductive layer 22, the fourth conductive layer 24, and the sixth conductive layer 26.

In some embodiments, the fifth conductive layer 25 has an upper portion 251 formed on the third conductive layer 23 opposite to the first conductive layer 23, and a lower portion 252 formed on the fourth conductive layer 24 opposite to the second conductive layer 22. The sixth conductive layer 26 has an upper portion 261 formed on the third conductive layer 23 opposite to the first conductive layer 23, and a lower portion 262 formed on the fourth conductive layer 24 opposite to the second conductive layer 22. The upper portion 251 of the fifth conductive layer 25 is spaced apart from the upper portion 261 of the sixth conductive layer 26. The lower portion 252 of the fifth conductive layer 25 is spaced apart from the lower portion 262 of the sixth conductive layer 26.

In some embodiments, a percentage of coverage of a projection of each of the first conductive layer 21, the second conductive layer 22, the third conductive layer 23, and the fourth conductive layer 24 onto the first surface of the PTC layer 10 over an area of the first surface of the PTC layer 10 ranges from 30% to 98%. In some embodiments, the percentage of coverage of the projection of each of the first conductive layer 21, the second conductive layer 22, the third conductive layer the 23, and the fourth conductive layer 24 ranges from 50% to 98%. In some embodiments, the percentage of coverage of the projection of each of the first conductive layer 21, the second conductive layer 22, the third conductive layer the 23, and the fourth conductive layer 24 ranges from 70% to 98%. In certain embodiments, the percentage of coverage of the projection of each of the first conductive layer 21, the second conductive layer 22, the third conductive layer 23, and the fourth conductive layer 24 ranges from 90% to 98%.

In some embodiments, a sum of a percentage of coverage of a projection of the upper portion 251 of the fifth conductive layer 25 and a percentage of coverage of a projection of the upper portion 261 of the sixth conductive layer 26 onto the first surface of the PTC layer 10 over the area of the first surface of the PTC layer 10 ranges from 30% to 98%, e.g., from 50% to 98%, from 70% to 98%, or from 90% to 98%.

In some embodiments, a sum of a percentage of coverage of a projection of the lower portion 262 of the sixth conductive layer 26 and a percentage of coverage of a projection of the lower portion 252 of the fifth conductive layer 25 ranges from 30% to 98%, e.g., from 50% to 98%, from 70% to 98%, or from 90% to 98%.

In some embodiments, the percentage of coverage of the projection of the first conductive layer 21 is the same as that of the second conductive layer 22; the percentage of coverage of the projection of the third conductive layer 23 is the same as that of the fourth conductive layer 24; the sum of the percentage of coverage of the projection of the lower portion 252 of the fifth conductive layer 25 and the percentage of coverage of the projection of the lower portion 262 of the sixth conductive layer 26 is the same as the sum of the percentage of coverage of the projection of the upper portion 251 of the fifth conductive layer 25 and the percentage of coverage of the projection of the upper portion 261 of the sixth conductive layer 26.

The percentage of coverage of the projection of the first conductive layer 21 or the second conductive layer 22 may be larger than, smaller than or equal to that of the third conductive layer 23 or the fourth conductive layer 24. The percentage of coverage of the projection of the first conductive layer 21 or the second conductive layer 22 may be larger than, smaller than, or equal to the sum of the percentage of coverage of the projection of the lower portion 262 and the percentage of coverage of the projection of the lower portion 252. The percentage of coverage of the projection of the first conductive layer 21 or the second conductive layer 22 may be larger than, smaller than, or equal to the sum of the percentage of coverage of the projection of the upper portion 261 and the percentage of coverage of the projection of the upper portion 251.

FIG. 2 is a cross-sectional schematic view of a variant structure of the circuit protection device 1 in accordance with some embodiments, and is similar to a structure shown in FIG. 1, except that the PTC layer 10 of the circuit protection device 1 shown in FIG. 2 is formed with a through hole 51. In some embodiments, the through hole 51 has an opening at the first surface, and a ratio of an area of the opening to an area of the first surface is smaller than 5%. In certain embodiments, the through hole 51 extends through one of the first conductive layer 21 and the second conductive layer 22. In certain embodiments, the through hole 51 extends through the first conductive layer 21 and the second conductive layer 22. It should be noted that the PTC layer 10 may be formed with a plurality of the through holes 51.

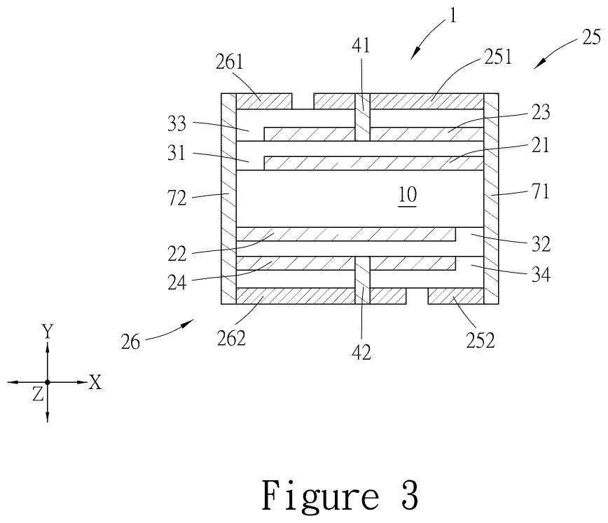

FIG. 3 is a cross sectional schematic view of a variant structure of the circuit protection device 1 in accordance with some embodiments, and is similar to the structure shown in FIG. 1, except that the circuit protection device 1 shown in FIG. 3 includes one or more conductive via(s). In some embodiments, the circuit protection device 1 includes a first conductive via 41 which electrically connects the third conductive layer 23 with the fifth conductive layer 25. The first conductive via 41 extends through a surface of the third conductive layer 23. In some embodiments, the first conductive via 41 is designed to electrically connect the first conductive layer 21 with the third conductive layer 23. In some other embodiments, the first conductive via 41 is designed to electrically connect the first conductive layer 21, the third conductive layer 23, and the fifth conductive layer 25.

In some embodiments, a cross section of the first conductive via 41 at the surface of the third conductive layer 23 has an area that is smaller than 20% of an area of the surface of the third conductive layer 23. In certain embodiments, the area of the cross section of the first conductive via 41 at the surface of the third conductive layer 23 is smaller than 5% of the area of the surface of the third conductive layer 23.

In some embodiments, the circuit protection devices 1 further includes a second conductive via 42 which electrically connects the fourth conductive layer 24 with the sixth conductive layer 26. The second conductive via 42 extends through a surface of the fourth conductive layer 24. In some embodiments, the second conductive via 42 is designed to electrically connect the second conductive layer 22 with the fourth conductive layer 24. In some other embodiments, the second conductive via 42 is designed to electrically connect the second conductive layer 22, the fourth conductive layer 24, and the sixth conductive layer 26.

In some embodiments, a cross section of the second conductive via 42 at the surface of the fourth conductive layer 24 has an area that is smaller than 20% of an area of the surface of the fourth conductive layer 24. In certain embodiments, the area of the cross section of the second conductive via 42 at the surface of the fourth conductive layer 24 is smaller than 5% of the area of the surface of the fourth conductive layer 24.

It should be noted that the number of each of the first conductive via 41 and the second conductive via 42 may vary according to the practical needs.

In some embodiments, the insulation structure 3 further includes a first insulation layer 31, a second insulation layer 32, a third insulation layer 33 and a fourth insulation layer 34. The first insulation layer 31 is disposed on the first surface of the PTC layer 10 and the first conductive layer 21 to separate the first conductive layer 21 and the third conductive layer 23 and to electrically isolate the first conductive layer 21 from the second electrode 72. The second insulation layer 32 is disposed on the second surface of the PTC layer 10 and the second conductive layer 22 to separate the second conductive layer 22 and the fourth conductive layer 24 and to electrically isolate the second conductive layer 22 from the first electrode 71. The third insulation layer 33 is disposed on the first insulation layer 31 and the third conductive layer 23 to separates the third conductive layer 23 and the fifth conductive layer 25 and to electrically isolate the third conductive layer 23 from the second electrode 72. The fourth insulation layer 34 is disposed on the second insulation layer 32 and the fourth conductive layer 24 to separate the fourth conductive layer 24 and the sixth conductive layer 26 and to electrically isolate the fourth conductive layer 24 from the first electrode 71.

In some embodiments, the insulation structure is made of a material including resin or a glass fiber. In certain embodiments, the resin includes polyester resin, phenolic resin, epoxy resin, polyphenylene ether resin, polyisocyanate resin, polyurethane resin, bismaleimide triazine resin, fluorine resin, polyimide resin, polyamide resin, polyolefin resin, or combinations thereof.

In some embodiments, the PTC layer 10 includes a non-grafted olefin-based polymer. In some other embodiments, the PTC layer 10 further includes a carboxylic acid anhydride-grafted olefin-based polymer. In certain embodiments, the olefin-based polymer for the PTC layer 10 includes polyethylene (PE), polypropylene (PP), polyethylene terephthalate (PET), polyester, perfluoroalkoxy alkane (PFA), plyamide, polyacrylonitrile, polystyrene, ethylene tetrafluoroethylene (ETFE), or combinations thereof.

In some embodiments, the PTC layer 10 further includes a conductive filler which includes carbon black powder, carbon nanotube, graphene, metal powder, conductive ceramic powder, or combinations thereof. In some other embodiments, the PTC layer 10 further includes a non-conductive filler.

The present disclosure will be further described with reference to the following examples. However, it should be understood that the following examples are merely for illustration purposes and should not be considered as limitations to the implementation of the present disclosure.

### Example 1 (E1)

10.25 g of high density polyethylene (HDPE) (commercially available from Formosa Plastics™ Corp., product name: Taisox® HDPE9002, serving as a non-grafted olefin-based polymer), 10.25 g of maleic anhydride grafted HDPE (commercially available from DuPont de Nemours™, Inc., product name: Fusabond® MB100D, serving as a carboxylic acid anhydride-grafted olefin-based polymer), and 29.5 g of carbon black powder (commercially available from Birla Carbon™ Inc., product name: Raven® 430 Ultra, DBP/D=0.95, and bulk density: 0.53 g/cm³) were compounded in a Brabender® mixer at 200 °C under 30 rpm for 10 minutes to obtain a compounded mixture. Next, the compounded mixture was hot pressed in a mold under 200 °C and 80 kg/cm² for 4 minutes to obtain a positive temperature coefficient (PTC) film with a thickness of 0.35 mm. Then, two copper sheets were respectively attached to two opposite surfaces of the PTC film (to respectively be formed into the first conductive layer 21 and the second conductive layer 22 after cutting (see below), followed by hot pressing under 200 °C and 80 kg/cm² for 4 minutes to form a PTC laminate with a thickness of 0.42 mm. The PTC laminate was cut into chips; each of the chips had a surface having a size of 5.2 mm×7.4 mm (38.48 mm²), and included a PTC layer 10 formed from the PTC film and the first conductive layer 21 and the second conductive layer 22. In each chip, each of the first conductive layer 21 and the second conductive layer 22 has a size of 36.4 mm² (i.e., an area of a projection of the first conductive layer 21 or the second conductive layer 22 on the surface of the PTC layer 10 is 36.4 mm²). A percentage of coverage of the projection of the first conductive layer 21 or the second conductive layer 22 over an area of the surface of the PTC layer 10 is 95%. Then, each chip was irradiated with a cobalt-60 gamma ray for a total irradiation dose of 150 kGy.

Next, each of the chips were sandwiched between two epoxy glass fiber layers (serving as the first insulating layer 31 and the second insulating layer 32), followed by hot pressing for 40 minutes at 150 °C under 80 kg/cm³ of pressure with two copper sheets (respectively serving as the third conductive layer 23 and the fourth conductive layer 24) to obtain semi-finished components. Each of third conductive layer 23 and the fourth conductive layer 24 has a size of 12.5 mm² (i.e., an area of a projection of the third conductive layer 23 or the fourth conductive layer 24 on the surface of the PTC layer 10 is 12.5 mm²). A percentage of coverage of the projection of the third conductive layer 23 or the fourth conductive layer 24 over the area of the surface of the PTC layer 10 is 32%.

Next, each of the semi-finished components were sandwiched between two epoxy glass fiber layers (serving as the third insulating layer 33 and the fourth insulating layer 34), followed by hot pressing for 40 minutes at 150 °C under 80 kg/cm³ of pressure with two copper films. Each of the two copper films was then patterned to form a trench and two portions separated from each other by the trench. The two portions of the one of the copper films had a total size of 12.5 mm² and were respectively served as the upper portion 251 of the fifth conductive layer 25 and the upper portion 261 of the sixth conductive layer 26 (i.e., a sum of an area of a projection of the upper portion 251 and a projection of the upper portion 261 on the surface of the PTC layer 10 is 12.5 mm²). The two portions of another one of the copper films had a total size of 12.5 mm², and were respectively served as the lower portion 252 of the fifth conductive layer 25 and the lower portion 262 of the sixth conductive layer 26 (i.e., a sum of an area of a projection of the lower portion 252 and a projection of the lower portion 262 on the surface of the PTC layer 10 is 12.5 mm²). Thus, semi-products were obtained. A sum of percentage of coverage of the projection of the upper portion 251 and the projection of the upper portion 261 on the surface of the PTC layer 10 over the area of the surface of the PTC layer 10 is 32%, and a sum of percentage of coverage of the projection of the lower portion 252 and the projection of the lower portion 262 on the surface of the PTC layer 10 over the area of the surface of the PTC layer 10 is 32%.

Thereafter, a first electrode 71 and a second electrode 72 were electroplated on each of the semi-products to form a PTC device having a structure shown in FIG. 1.

### Example 2 and Example 3 (E2 and E3)

The procedures and conditions in preparing PTC devices of E2 and E3 are similar to those of E1, except that the sizes of the conductive layers 21 to 26 were different. The details are shown in Table 1.

### Example 4 (E4)

The procedures and conditions in preparing the PTC device of E4 are similar to those of E3, except that the PTC layer 10 of E4 further includes a through hole 51 having an opening at the first surface of the PTC layer 10. An area of the opening at the first surface of the PTC layer 10 is 0.78 mm² (having a diameter of 1 mm). A ratio of an area of the opening of the through hole to an area of the first surface was 2.07%. The structure of the PTC device of E4 is shown in FIG. 2, and the details are shown in Table 1.

### Example 5 (E5)

The procedures and conditions in preparing the PTC device of E5 are similar to those of E3, except that the PTC device of E5 further includes a first conductive via 41 and a second conductive via 42. A cross section of the first conductive via 41 at the surface of the third conductive layer 23 has an area that is 0.78 mm² (having a diameter of 1 mm), and a cross section of the second conductive via 42 at the surface of the fourth conductive layer 24 has an area that is 0.78 mm² (having a diameter of 1 mm). The cross section of the first conductive via 41 at the surface of the third conductive layer 23 has the area that is 2.19% of an area of the surface of the third conductive layer 23. The cross section of the second conductive via 42 at the surface of the fourth conductive layer 24 has the area that is 2.19% of an area of the surface of the fourth conductive layer 24. The structure of the PTC device of E5 is shown in FIG. 3, and further detailed information is shown in Table 1.

### Example 6 (E6)

The procedures and conditions in preparing PTC device of E6 are similar to those of E5, except that the PTC device of E6 further includes a through hole 51 that has an opening at the first surface of the PTC layer 10. An area of the opening at the first surface of the PTC layer 10 is 0.78 mm² (having a diameter of 1 mm). A ratio of an area of the opening of the through hole to the area of the first surface was 2.07%. Detailed information of the PTC device of E6 is shown in Table 1.

### Comparative Example 1 (CE1)

The procedures and conditions in preparing PTC devices of CE1 are similar to those of E1, except that each of the PTC devices of CE1 did not include the third and fourth conductive layers 23, 24, and the third and fourth insulating layers 33, 34, and had different sizes of the conductive layers. These details are shown in Table 1.

### Comparative Example 1 (CE2)

The procedures and conditions in preparing PTC devices of CE2 are similar to those of E1, except that each of the PTC devices of CE2 did not include the third and fourth conductive layers 23, 24, and the third and fourth insulating layers 33, 34, and had different sizes of the conductive layers. In addition, the PTC layer 10 of CE2 further includes a through hole 51 having a structure similar to that formed in E4. These details are shown in Table 1.

TABLE 1

| | Area of projection of | Area of projection of | Total size of upper portions |
|---|---|---|---|
| | first/second conductive | third/fourth conductive | of fifth and sixth conductive |
| | layer (percentage of | layer (percentage of | layers (sum of percentage |
| | coverage of projection | coverage of projection | of coverage of projections |
| | of first/second | of third/fourth | of upper portions of fifth |
| | conductive layer) | conductive layer) | and sixth conductive layers) ^{[1]} |
| E1 | 36.4 mm² (95%) | 12.5 mm² (32%) | 12.5 mm² (32%) |
| E2 | 36.4 mm² (95%) | 19.8 mm² (51%) | 19.8 mm² (51%) |
| E3 | 36.4 mm² (95%) | 36.4 mm² (95%) | 36.4 mm² (95%) |
| E4 | 36.4 mm² (97%) | 36.4 mm² (97%) | 36.4 mm² (97%) |
| E5 | 36.4 mm² (95%) | 35.6 mm² (93%) | 36.4 mm² (95%) |
| E6 | 36.4 mm² (97%) | 35.6 mm² (94%) | 36.4 mm² (97%) |
| CE1 | 36.4 mm² (95%) | NA | 10.4 mm² (27%) |
| CE2 | 36.4 mm² (97%) | NA | 10.4 mm² (28%) |

^{[1]} The sum of the percentage of coverage of the projection of the lower portion 252 and the percentage of coverage of the projection of the lower portion 262 is the same as the sum of the percentage of coverage of the projection of the upper portion 251 and the percentage of coverage of the projection of the upper portion 261.

### Resistance Test

10 samples from each of E1 to E6 and CE1 to CE2 were subjected to a resistance test using an ohmmeter at 25 °C to determine an average initial resistance (Rᵢ). The results are presented in Table 2.

### Hold Current Test

10 samples from each of E1 to E6 and CE1 to CE2 were subjected to a hold current test under a voltage of 16 Vdc for 10 minutes without causing them to trip under 25 °C to determine the hold currents of the samples. The results are presented in Table 2.

From Table 2, it is apparent that the hold currents of the samples from E1 to E6 (ranging from 2.1 A to 2.7 A) are higher than those from CE1 and CE2 (2.0 A), and the samples of E5 and E6 have the largest hold currents.

### Switching Cycle Test

10 samples from each of E1 to E6 and CE1 to CE2 were subjected to a switching cycle test to determine resistances of the samples under a voltage of 16 Vdc and a current of 10 A by switching each test sample on for 60 seconds and then off for 60 seconds per cycle for 6000 cycles. Average resistances of the samples of each of E1 to E6 and CE1 to CE2 before (Rᵢ) and after (R_{f}) 6000 cycles were measured. A percentage of average resistance variation (R_{f}/Rᵢ×100%) in each of E1 to E6 and CE1 to CE2 was calculated and is presented in Table 2.

From Table 2, it is noted that the percentages of average resistance variation of the samples from E1 to E6 (ranging from 3398% to 4537%) are smaller than those from CE1 and CE2 (ranging from 4609% to 4981%), and the samples E6 having the vias and the opening exhibit the smallest percentage of average resistance variation at 3398%.

### Aging Test

10 samples of each of E1 to E6 and CE1 and CE2 were subjected to an aging test where a current of 10 A and 16 Vdc was applied to each of the samples for 1000 hours. An average final resistance (R_{f}) of the samples for each E1 to E6 and CE1 and CE2 was obtained after 1000 hours of applying the current and the voltage. A percentage of average resistance variation (R_{f}/Rᵢ×100%) in each of E1 to E6 and CE1 and CE2 was calculated and is presented in Table 2.

From Table 2, it is shown that the percentages of average resistance variations of samples from E1 to E6 (ranging from 472% to 685%) are smaller than those from CE1 and CE2 (ranging from 718% to 764%), and the samples from E6 having the vias and the opening exhibit the smallest percentage of average resistance variation of 472%.

TABLE 2

| | | Hold | | | | |
|---|---|---|---|---|---|---|
| | Rᵢ | Current | Switching Cycles Test | | Aging Test | |
| | (ohm) | (A) | R_{f} (ohm) | R_{f}/Rᵢ | R_{f} (ohm) | R_{f}/Rᵢ |
| E1 | 0.054 | 2.1 | 2.450 | 4537% | 0.370 | 685% |
| E2 | 0.054 | 2.3 | 2.235 | 4139% | 0.345 | 639% |
| E3 | 0.053 | 2.5 | 1.955 | 3689% | 0.295 | 557% |
| E4 | 0.054 | 2.5 | 1.925 | 3565% | 0.290 | 537% |
| E5 | 0.054 | 2.7 | 1.845 | 3417% | 0.265 | 491% |
| E6 | 0.054 | 2.7 | 1.835 | 3398% | 0.255 | 472% |
| CE1 | 0.053 | 2.0 | 2.640 | 4981% | 0.405 | 764% |
| CE2 | 0.055 | 2.0 | 2.535 | 4609% | 0.395 | 718% |

In summary, through the particular design in the number of the conductive layer, the through hole 51, and the conductive vias 41, 42, and controlling the percentage of coverage of the projection of each of the conductive layers 21 to 26, the circuit protection device of the present disclosure is able to exhibit superior thermal stability with desired electric characteristics, such that durability and reliability of the circuit protection device may be significantly improved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A circuit protection device, comprising:
a positive temperature coefficient (PTC) layer having a first surface and a second surface opposite to said first surface;
a first conductive layer disposed on said first surface of said PTC layer;
a second conductive layer disposed on said second surface of said PTC layer;
a third conductive layer disposed on said PTC layer and electrically connected to said first conductive layer;
a fourth conductive layer disposed on said PTC layer and electrically connected to said second conductive layer;
a fifth conductive layer disposed on said PTC layer and electrically connected to said first conductive layer and said third conductive layer;
a sixth conductive layer disposed on said PTC layer and electrically connected to said second conductive layer and said fourth conductive layer;
an insulation structure which separates said first conductive layer, said second conductive layer, said third conductive layer, said fourth conductive layer, said fifth conductive layer, and said sixth conductive layer;
a first electrode electrically connected to said PTC layer, said first conductive layer, said third conductive layer, and said fifth conductive layer; and
a second electrode electrically connected to said PTC layer, said second conductive layer, said fourth conductive layer, and said sixth conductive layer.

2. The circuit protection device as claimed in claim 1, wherein a percentage of coverage of a projection of each of said first conductive layer, said second conductive layer, said third conductive layer, and said fourth conductive layer onto said first surface of said PTC layer over an area of said first surface of said PTC layer ranges from 30% to 98%.

3. The circuit protection device as claimed in claim 2, wherein the percentage of coverage of the projection of each of said first conductive layer, said second conductive layer, said third conductive layer, and said fourth conductive layer ranges from 50% to 98%.

4. The circuit protection device as claimed in claim 3, wherein the percentage of coverage of the projection of each of said first conductive layer, said second conductive layer, said third conductive layer, and said fourth conductive layer ranges from 90% to 98%.

5. The circuit protection device as claimed in claim 1, wherein said fifth conductive layer has an upper portion formed on said third conductive layer opposite to said first conductive layer, and a lower portion formed on said fourth conductive layer opposite to said second conductive layer, said sixth conductive layer having an upper portion formed on said third conductive layer opposite to said first conductive layer, and a lower portion formed on said fourth conductive layer opposite to said second conductive layer, said upper portion of said fifth conductive layer being spaced apart from said upper portion of said sixth conductive layer, said lower portion of said fifth conductive layer being spaced apart from said lower portion of said sixth conductive layer.

6. The circuit protection device as claimed in claim 5, wherein a sum of a percentage of coverage of a projection of said upper portion of said fifth conductive layer and a percentage of coverage of a projection of said upper portion of said sixth conductive layer onto said first surface of said PTC layer over an area of said first surface of said PTC layer ranges from 30% to 98%.

7. The circuit protection device as claimed in claim 6, wherein the sum of the percentage of coverage of the projection of said upper portion of said fifth conductive layer and the percentage of coverage of the projection of said upper portion of said sixth conductive layer ranges from 50% to 98%.

8. The circuit protection device as claimed in claim 6, wherein the sum of the percentage of coverage of the projection of said upper portion of said fifth conductive layer and the percentage of coverage of the projection of said upper portion of said sixth conductive layer ranges from 90% to 98%.

9. The circuit protection device as claimed in claim 5, wherein a sum of a percentage of coverage of a projection of said lower portion of said sixth conductive layer and a percentage of coverage of a projection of said lower portion of said fifth conductive layer onto said first surface of said PTC layer over an area of said first surface of said PTC layer ranges from 30% to 98%.

10. The circuit protection device as claimed in claim 9, wherein the sum of the percentage of coverage of the projection of said lower portion of said sixth conductive layer and the percentage of coverage of the projection of said lower portion of said fifth conductive layer ranges from 50% to 98%.

11. The circuit protection device as claimed in claim 9, wherein the sum of the percentage of coverage of the projection of said lower portion of said sixth conductive layer and the percentage of coverage of the projection of said lower portion of said fifth conductive layer ranges from 90% to 98%.

12. The circuit protection device as claimed in claim 1, wherein said PTC layer is formed with a through hole.

13. The circuit protection device as claimed in claim 9, wherein said through hole has an opening at said first surface of said PTC layer, and a ratio of an area of said opening to an area of said first surface is smaller than 5%.

14. The circuit protection device as claimed in claim 1, further comprising:
a first conductive vi which electrically connects said third conductive layer with said fifth conductive layer.

15. The circuit protection device as claimed in claim 14, wherein said first conductive via extends through a surface of said third conductive layer, and a cross section of said first conductive via at said surface of said third conductive layer has an area that is smaller than 5% of an area of said surface of said third conductive layer.

16. The circuit protection device as claimed in claim 14, further comprising:
a second conductive via which electrically connects said fourth conductive layer with said sixth conductive layer.

17. The circuit protection device as claimed in claim 16, wherein said second conductive via extends through a surface of said fourth conductive layer, and a cross section of said second conductive via at said surface of said fourth conductive layer has an area that is smaller than 5% of an area of said surface of said fourth conductive layer.

18. The circuit protection device as claimed in claim 1, wherein said insulation structure includes:
a first insulation layer which is disposed on said first surface of said PTC layer and which separates said first conductive layer and said third conductive layer;
a second insulation layer which is disposed on said second surface of said PTC layer and which separates said second conductive layer and said fourth conductive layer;
a third insulation layer which is disposed on said third conductive layer and which separates said third conductive layer and said fifth conductive layer; and
a fourth insulation layer which is disposed on said fourth conductive layer and which separates said fourth conductive layer and said sixth conductive layer.

19. The circuit protection device as claimed in claim 1, wherein said PTC layer includes a non-grafted olefin-based polymer.

20. The circuit protection device as claimed in claim 1, wherein said PTC layer further includes a carboxylic acid anhydride-grafted olefin-based polymer.
